(19) United States
(12) Patent Application Publication
(10) Pub. No.: US 2010/0171838 A1
(43) Pub. Date: Jul. 8, 2010

(54) METHOD AND APPARATUS FOR EVALUATING INTERFERENCE BETWEEN DIGITAL TV BROADCASTING SYSTEM USING 8-VSB MODULATION METHOD AND COGNITIVE RADIO SYSTEM USING ORTHOGONAL FREQUENCY DIVISION MULTIPLE ACCESS

(75) Inventors: Young-Keun Yoon, Choongcheongbuk-do (KR); Heon Jin Hong, Daejeon-city (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon-city (KR)

(21) Appl. No.: 12/602,426

(22) PCT Filed: May 27, 2008
(86) PCT No.: PCT/KR2008/002950

§ 371 Date: Nov. 30, 2009

(30) Foreign Application Priority Data
May 30, 2007 (KR) 10-2007-0052933

(51) Int. Cl. H04N 17/00

(52) U.S. Cl. 348/193; 348/E17.001

(57) ABSTRACT

A apparatus for evaluating interference of a cognitive radio transmission signal with digital TV broadcasting includes a cognitive radio transmission unit generating and transmitting an interference signal using orthogonal frequency division multiple access (OFDMA), a broadcast transmission unit generating and transmitting a baseband digital TV broadcast signal containing data about a program to be broadcast, and a broadcast receiving evaluation unit evaluating a signal interference on the digital TV broadcast signal due to the interference signal from a signal combining a broadcast signal that the broadcast transmission unit transmits and the interference signal that the cognitive radio transmission unit transmits, by the signal interference.

### TECHNICAL FIELD

The present invention relates to a method and apparatus for evaluating interference between a digital broadcasting system using an 8-VSB (8-level vestigial side-band) modulation method and a cognitive radio system using orthogonal frequency division multiple access (OFDMA), and a recording medium having recorded thereon a program for executing the method.

### BACKGROUND ART

A cognitive radio system is a system to actively find and use a frequency band that is not in use at a particular time band, not merely receive a particular frequency band assigned by the Government. Recently, cognitive radio systems have been widely discussed by the IEEE802.22 TG group, especially in terms of standardization of a physical layer and MAC layer.

The present target of the cognitive radio system is to provide a wireless Internet service within a 33 km radius of a server of the cognitive radio system. The frequency to be used for the cognitive radio system is VHF and UHF broadcasting bands. However, these broadcasting bands are currently assigned to analog and digital TV broadcasting services and are being used therefor.

Thus, it is essential to perform interference evaluation in order for a TV broadcasting system and the cognitive radio system to share the broadcasting bands.

### DISCLOSURE OF INVENTION

### Technical Problem

To predict the effect of wave interference, the most preferred method would be to develop a real system and test the system in the field. However, that is inappropriate for a system that is currently under development in terms of development costs and the time for testing to be completed.

A computer simulation may be another method that could be used. This method is widely used not only to analyze an interference phenomenon between communications services but also to design a new communications system. The most important issue in terms of the prediction of the performance of a real communications system through the computer simulation is to determine a method that can represent a baseband signal process as accurately as possible.

### Technical Solution

To solve the above and/or other problems, the present invention provides a method and apparatus for evaluating interference between a digital broadcasting system using an 8-VSB (8-level vestigial side-band) modulation method and a cognitive radio system using orthogonal frequency division multiple access (OFDMA).

Also, the present invention provides an apparatus for evaluating interference of a cognitive radio transmission signal with digital TV broadcasting, which comprises a cognitive radio transmission unit generating and transmitting an interference signal using orthogonal frequency division multiple access (OFDMA), a broadcast transmission unit generating and transmitting a baseband digital TV broadcast signal containing data about a program to be broadcast, and a broadcast receiving evaluation unit evaluating a signal interference on the digital TV broadcast signal due to the interference signal from a signal combining a broadcast signal that the broadcast transmission unit transmits and the interference signal that the cognitive radio transmission unit transmits, by the signal interference.

### Advantageous Effects

As described above, an apparatus and method of the evaluation of the interference between the digital TV broadcast system using 8-VSB and the cognitive radio system using OFDMA is provided. The apparatus and method have an effect of determining a protection ratio to restrict the generation of an interference signal by using the cognitive radio system.

### DESCRIPTION OF DRAWINGS

FIG. 1 is a block diagram illustrating the structure of an apparatus for performing an interference evaluation simulation according to an embodiment of the present invention;

FIG. 2 is a block diagram illustrating the structure of an apparatus for performing an interference evaluation simulation according to another embodiment of the present invention;

FIG. 3 illustrates a cognitive radio transmission unit of the apparatus for performing an interference evaluation simulation, according to an embodiment of the present invention;

FIG. 4 illustrates a broadcast receiving evaluation unit of the apparatus for performing an interference evaluation simulation, according to an embodiment of the present invention;

FIG. 5 is a graph showing an interference evaluation as a result of performing a digital TV broadcasting system using an 8-VSB (8-level vestigial side-band) modulation method according to an interference signal, according to an embodiment of the present invention;

FIG. 6 is a graph showing a result of calculating a protection ratio according to frequency spacing according to an embodiment of the present invention;

FIG. 7 is a flowchart for explaining an interference evaluation simulation according to an embodiment of the present invention;

FIG. 8 is a flowchart for explaining an interference evaluation simulation according to another embodiment of the present invention;

FIG. 9 is a flowchart for explaining an interference signal generation step according to an embodiment of the present invention;

FIG. 10 is a flowchart for explaining a step of receiving a broadcast signal and an interference signal and generating signal interference between the broadcast signal and the interference signal according to an embodiment of the present invention; and

FIG. 11 is a flowchart for explaining a signal interference evaluation step according to an embodiment of the present invention.

### BEST MODE

According to an aspect of the present invention, an apparatus for evaluating interference of a cognitive radio transmission signal with digital TV broadcasting, which comprises a cognitive radio transmission unit generating and transmitting an interference signal using OFDMA, a broadcast transceiving unit transmitting a digital TV broadcast signal and receiving the transmitted broadcast signal and the interference signal from the cognitive radio transmission unit transmits, and a broadcast receiving evaluation unit evaluating signal interference on the digital TV broadcast signal due to the interference signal from a signal that the broadcast transceiving unit receives.

The cognitive radio transmission unit comprises an interference signal generation unit generating a baseband interference signal using OFDMA, and an interference signal control unit controlling a power or center frequency of the interference signal.

The broadcast transceiving unit comprises a broadcast transmission unit generating and transmitting a baseband digital TV broadcast signal containing data about a program to be broadcast, and a broadcast receiving unit receiving the baseband digital TV broadcast signal and the interference signal that the cognitive radio transmission unit transmits.

The broadcast receiving evaluation unit comprises an interference evaluation unit calculating a symbol error rate (SER) based on a power and center frequency of the interference signal, and a protection ratio calculation unit calculating a channel protection ratio indicating signal interference on the broadcast signal by the interference signal according to frequency spacing by using the SER calculated by the interference evaluation unit.

The digital TV broadcast signal is generated using an 8-VSB modulation method.

According to an aspect of the present invention, a method for evaluating interference on a digital TV broadcast by a cognitive radio transmission signal, which comprises generating and transmitting an interference signal using OFDMA, generating a baseband digital TV broadcast signal containing data about a program to be broadcast, and evaluating signal interference on the digital TV broadcast signal by the interference signal from a signal combining the digital TV broadcast signal and the interference signal.

According to an aspect of the present invention, a method for evaluating interference on a digital TV broadcast by a cognitive radio transmission signal, which comprises generating and transmitting an interference signal using OFDMA, transmitting a digital TV broadcast signal and receiving the digital TV broadcast signal and the interference signal, and evaluating signal interference on the digital TV broadcast signal by the interference signal from the received digital TV broadcast signal.

The generating of an interference signal using OFDMA comprises generating and transmitting a baseband interference signal using OFDMA, and controlling a power or a center frequency of the interference signal.

The transmitting of a digital TV broadcast signal and receiving the broadcast signal and the interference signal comprises generating and transmitting a baseband digital TV broadcast signal containing data about a program to be broadcast, and receiving the baseband digital TV broadcast signal and the interference signal.

The evaluating of signal interference comprises calculating an SER based on a power and center frequency of the interference signal, and calculating a channel protection ratio indicating signal interference on the broadcast signal by the interference signal according to frequency spacing by using the calculated SER.

The digital TV broadcast signal is generated using an 8-VSB modulation method.

### Mode for Invention

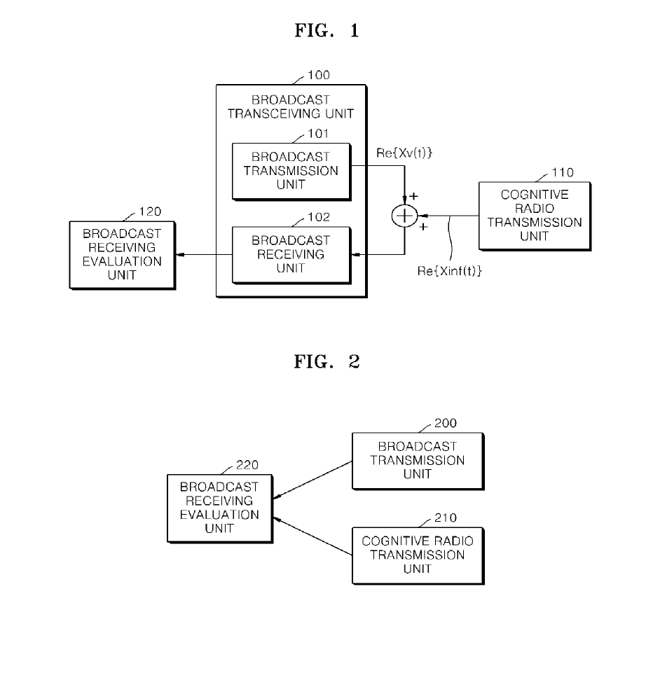

FIG. 1 is a block diagram illustrating the structure of an apparatus for performing an interference evaluation simulation according to an embodiment of the present invention. Referring to FIG. 1, the apparatus for performing an interference evaluation simulation according to the present invention includes a broadcast transceiving unit 100, a cognitive radio transmission unit 110, and a broadcast receiving evaluation unit 120.

The broadcast transceiving unit 100 includes a broadcast transmission unit 101 and a broadcast receiving unit 102. The broadcast transceiving unit 100 transceives digital TV broadcasting using an 8-VSB (8-level vestigial side-band) modulation method. The broadcast transmission unit 101 transmits digital TV broadcasting using the 8-VSB modulation method. The broadcast receiving unit 102 receives digital TV broadcasting using the 8-VSB modulation method and interference occurs due to an interference signal.

A receiving signal Xr(t) that the broadcast receiving unit 102 receives is represented as a sum of a digital TV broadcast signal Re{Xv(t)}, excluding a thermal noise signal, which the broadcast transmission unit 101 transmits and an interference signal Re{Xinf(t)} that the cognitive radio transmission unit 110 transmits. The cognitive radio transmission unit 110 generates an interference signal using orthogonal frequency division multiple access (OFDMA). The generated interference signal interferes with the broadcast receiving unit 102.

The broadcast receiving evaluation unit 120 quantatively evaluates the amount of interference on the digital TV broadcasting system using the 8-VSB modulation method due to the interference signal generated in a cognitive radio system using OFDMA and calculates a channel protection ratio.

FIG. 2 is a block diagram illustrating the structure of an apparatus for performing an interference evaluation simulation according to another embodiment of the present invention. Referring to FIG. 2, an apparatus for performing an interference evaluation simulation according to the present embodiment includes a broadcast transmission unit 200, a cognitive radio transmission unit 210, and a broadcast receiving evaluation unit 220. The function and operation of each constituent element is similar to those of each constituent element of FIG. 1. The broadcast transmission unit 200, the cognitive radio transmission unit 210, and the broadcast receiving evaluation unit 220, respectively correspond to the broadcast transmission unit 101, the cognitive radio transmission unit 110, and the broadcast receiving evaluation unit 220.

FIG. 3 illustrates a cognitive radio transmission unit of the apparatus for performing an interference evaluation simulation, according to an embodiment of the present invention. Referring to FIG. 3, the cognitive radio transmission unit 110 includes an interference signal generation unit 301 and an interference signal control unit 302. The interference signal generation unit 301 generates a baseband interference signal using OFDMA. The interference signal control unit 302 controls the amount of power and transmission frequency of the baseband interference signal using OFDMA.

When the amount of power and the center frequency of the interference signal are controlled, the amount of interference on the digital TV broadcasting system using the 8-VSB modulation method is changed. That is, when the amount of interference signal power is decreased and the center frequency of the interference signal is keeping apart from a center frequency of the digital TV broadcasting system, the amount of interference is decreased.

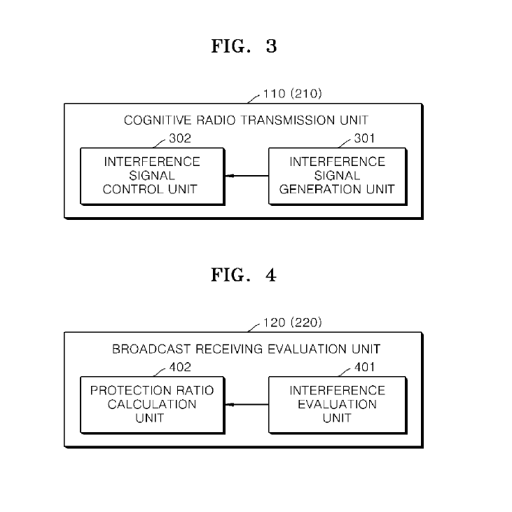

FIG. 4 illustrates a broadcast receiving evaluation unit of the apparatus for performing an interference evaluation simulation, according to an embodiment of the present invention. In FIG. 4, the amount of interference on the digital TV broadcasting system using the 8-VSB modulation method due to the interference signal generated in a cognitive radio system using OFDMA is quantatively evaluated. Referring to FIG. 4, the broadcast receiving evaluation unit 120 includes an interference evaluation unit 401 and a protection ratio calculation unit 402.

The interference evaluation unit 401 evaluates the amount of interference on the digital TV broadcasting system using the 8-VSB modulation method, by using a symbol error rate (SER). The protection ratio calculation unit 402 evaluates the protection ratio of the digital TV broadcasting system using the 8-VSB modulation method to restrict the interference due to the interference signal using OFDMA according to the frequency spacing by using the result obtained by the interference evaluation unit 401.

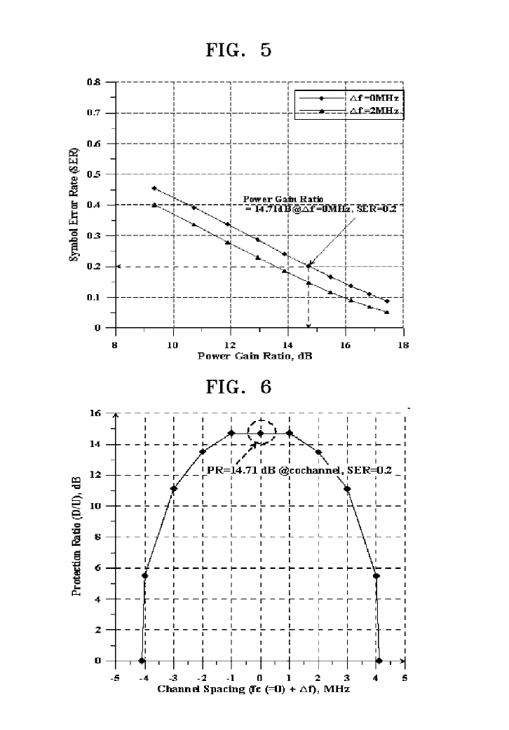

FIG. 5 is a graph showing the interference evaluation as a result of performing a digital TV broadcasting system using the 8-VSB modulation method according to an interference signal, according to an embodiment of the present invention. In FIG. 5, the X axis indicates a power gain ratio, that is, the amount of a relative interference signal power in dB, when the digital TV broadcast signal using the 8-VSB modulation method is normalized with ‘1’ and the Y axis indicates a SER with respect to the digital TV broadcast signal using the 8-VSB modulation method.

The graphs indicate the SER according to the frequency spacing (Δf=0 MHz or Δf=2 MHz) and the SER according to the power gain ratio. For example, as the frequency spacing (Δf) increases and the power gain ratio increases, that is, the strength of the interference signal using OFDMA gradually decreases, the SER tends to decrease.

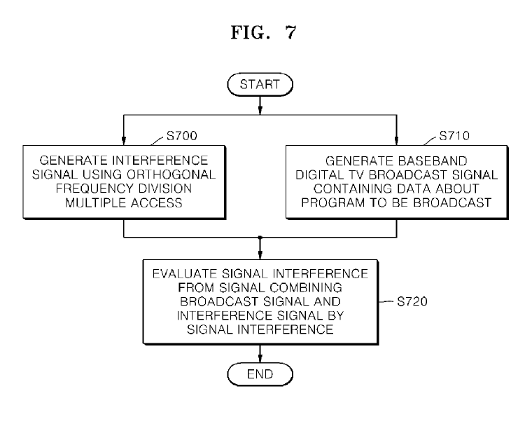

FIG. 6 is a graph showing a result of calculating a protection ratio according to frequency spacing according to an embodiment of the present invention. Referring to FIG. 6, the X axis indicates a relative channel spacing (fc+Δf), in MHz, with respect to the center frequency of the interference signal using OFDMA when the center frequency of the digital TV broadcast signal using the 8-VSB modulation method is set to 0. The Y axis indicates the protection ratio (D/U) of the digital TV broadcast signal using the 8-VSB modulation method, in dB, to restrict the interference due to the interference signal using OFDMA.

According to the graph in FIG. 6, when the relative frequency spacing is 0, that is, the center frequency fc of the digital TV broadcast signal using the 8-VSB modulation method and the center frequency of the interference signal using OFDMA are the same, the protection ratio is the largest. As the relative frequency spacing increases, the protection ratio decreases.

FIG. 7 is a flowchart for explaining an interference evaluation simulation according to an embodiment of the present invention. Referring to FIG. 7, an interference signal using OFDMA is generated (S700). A baseband digital TV broadcast signal containing data about a program to be broadcast is generated (S710). The interference on the digital TV broadcast signal due to the interference signal is evaluated from a signal combining the digital TV broadcast signal and the interference signal by the signal interference (S720).

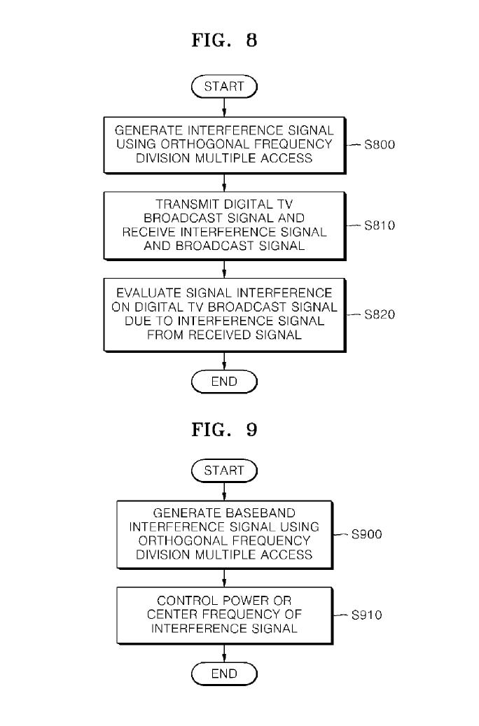

FIG. 8 is a flowchart for explaining an interference evaluation simulation according to another embodiment of the present invention. Referring to FIG. 8, an interference signal using OFDMA is generated (S800). A digital TV broadcast signal is transmitted and the broadcast signal and the interference signal are received (S810). The signal interference on the digital TV broadcast signal due to the interference signal is evaluated from the received broadcast signal (S820).

FIG. 9 is a flowchart for explaining an interference signal generation step according to an embodiment of the present invention. Referring to FIG. 9, a baseband interference signal using OFDMA is generated (S900). The power or center frequency of the interference signal is controlled (S901).

FIG. 10 is a flowchart for explaining a step of receiving a broadcast signal and an interference signal and generating signal interference between the broadcast signal and the interference signal according to an embodiment of the present invention. Referring to FIG. 10, a baseband digital TV broadcast signal containing data about a program to be broadcast is generated (S1000). The broadcast signal and the interference signal are received (S1001).

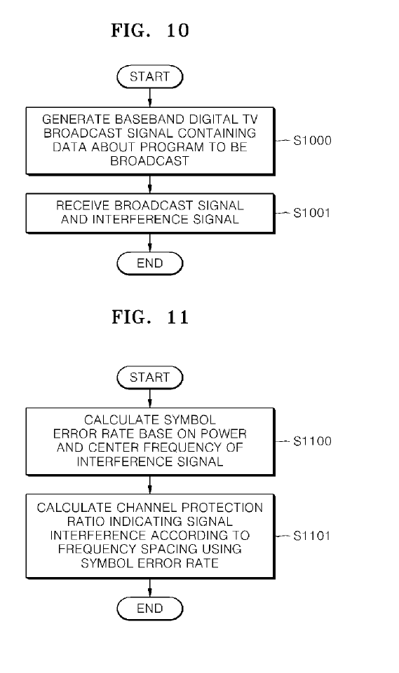

FIG. 11 is a flowchart for explaining a signal interference evaluation step according to an embodiment of the present invention. Referring to FIG. 11, a SER is calculated based on the power and the center frequency of the interference signal (S1100). A channel protection ratio indicating the signal interference on the broadcast signal due to the interference signal according to the frequency spacing is produced by using the calculated SER (S1101).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While this invention has been particularly shown and described with reference to preferred embodiments thereof, it will be understood by those of ordinary skill in the art that various changes in form and details may be made therein without departing from the spirit and scope of the invention as defined by the appended claims.

1. A apparatus for evaluating interference of a cognitive radio transmission signal with digital TV broadcasting, the apparatus comprising:
a cognitive radio transmission unit generating and transmitting an interference signal using orthogonal frequency division multiple access (OFDMA);
a broadcast transmission unit generating and transmitting a baseband digital TV broadcast signal containing data about a program to be broadcast; and
a broadcast receiving evaluation unit evaluating a signal interference on the digital TV broadcast signal due to the interference signal from a signal combining a broadcast signal that the broadcast transmission unit transmits and the interference signal that the cognitive radio transmission unit transmits, by the signal interference.

2. A apparatus for evaluating interference of a cognitive radio transmission signal with digital TV broadcasting, the apparatus comprising:
a cognitive radio transmission unit generating and transmitting an interference signal using OFDMA;
a broadcast transceiving unit transmitting a digital TV broadcast signal and receiving the transmitted broadcast signal and the interference signal from the cognitive radio transmission unit transmits; and
a broadcast receiving evaluation unit evaluating signal interference on the digital TV broadcast signal due to the interference signal from a signal that the broadcast transceiving unit receives.

3. The apparatus of either claim 1, wherein the cognitive radio transmission unit comprises:
an interference signal generation unit generating a baseband interference signal using OFDMA; and
an interference signal control unit controlling a power or center frequency of the interference signal.

4. The apparatus of claim 2, wherein the broadcast transceiving unit comprises:
a broadcast transmission unit generating and transmitting a baseband digital TV broadcast signal containing data about a program to be broadcast; and
a broadcast receiving unit receiving the baseband digital TV broadcast signal and the interference signal that the cognitive radio transmission unit transmits.

5. The apparatus of claim 1, wherein the broadcast receiving evaluation unit comprises:
an interference evaluation unit calculating a symbol error rate (SER) based on a power and center frequency of the interference signal; and
a protection ratio calculation unit calculating a channel protection ratio indicating signal interference on the broadcast signal by the interference signal according to frequency spacing by using the SER calculated by the interference evaluation unit.

6. A method for evaluating interference on a digital TV broadcast by a cognitive radio transmission signal, the method comprising:
generating and transmitting an interference signal using OFDMA;
generating a baseband digital TV broadcast signal containing data about a program to be broadcast; and
evaluating signal interference on the digital TV broadcast signal by the interference signal from a signal combining the digital TV broadcast signal and the interference signal.

7. A method for evaluating interference on a digital TV broadcast by a cognitive radio transmission signal, the method comprising:
generating and transmitting an interference signal using OFDMA;
transmitting a digital TV broadcast signal and receiving the digital TV broadcast signal and the interference signal; and
evaluating signal interference on the digital TV broadcast signal by the interference signal from the received digital TV broadcast signal.

8. The method of claim 6, wherein the generating of an interference signal using OFDMA comprises:
generating and transmitting a baseband interference signal using OFDMA; and
controlling a power or a center frequency of the interference signal.

9. The method of claim 7, wherein the transmitting of a digital TV broadcast signal and receiving the broadcast signal and the interference signal comprises:
generating and transmitting a baseband digital TV broadcast signal containing data about a program to be broadcast; and
receiving the baseband digital TV broadcast signal and the interference signal.

10. The method of claim 6, wherein the evaluating of signal interference comprises:
calculating an SER based on a power and center frequency of the interference signal; and
calculating a channel protection ratio indicating signal interference on the broadcast signal by the interference signal according to frequency spacing by using the calculated SER.
